(19) United States
(12) Patent Application Publication
(10) Pub. No.: US 2025/0016885 A1
(43) Pub. Date: Jan. 9, 2025

(54) ENABLING UNICAST AND MULTICAST COMMUNICATIONS FOR MULTICAST AND/OR BROADCAST SERVICES

(71) Applicant: Google LLC, Mountain View, CA (US)

(72) Inventor: Chih-Hsiang Wu, Taoyuan city (TW)

(21) Appl. No.: 18/701,926

(22) PCT Filed: Oct. 18, 2022
(86) PCT No.: PCT/US2022/046936

§ 371 Date: Apr. 16, 2024

Related U.S. Application Data
(60) Provisional application No. 63/270,173, filed on Oct. 21, 2021.

(51) Int. Cl. H04W 76/40; H04W 76/12

(52) U.S. Cl. CPC H04W 76/40; H04W 76/12

(57) ABSTRACT

A method, implemented in a User Equipment (UE), for receiving Multicast and/or Broadcast services (MBS) data includes performing a Protocol Data Unit (PDU) session establishment procedure with a Core Network (CN) to establish a PDU session to join an MBS session, including receiving, from a Radio Access Network (RAN), at least one first configuration for configuring radio resources for the PDU session; performing an MBS session join procedure with the CN to join the MBS session, including receiving, from the CN, an MBS session identifier and receiving, from the RAN, at least one second configuration for configuring radio resources for the MBS session; receiving, from the CN via the RAN, first MBS data of the MBS session in accordance with the at least one first configuration; and receiving, from the CN via the RAN, second MBS data of the MBS session in accordance with the at least one second configuration.

### FIELD OF THE DISCLOSURE

This disclosure relates to wireless communications and, more particularly, to enabling setup of radio resources for unicast and multicast communications.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, it is unclear how a base station receives an MBS data packet from a core network and how the base station transmits each MBS data packet to UEs.

### SUMMARY

Using the techniques of this disclosure, a core network (CN) and a base station communicate MBS traffic for multiple UEs via a shared (or “common”) tunnel between the CN and the base station. The base station can generate and provide the configuration of the common tunnel, such as an Internet Protocol (IP) address and/or a Tunnel Endpoint Identifier (TEID), to the CN in response to a request for the configuration from the CN.

An example embodiment of these techniques is a method in a base station for managing transmission of multicast and/or broadcast services (MBS). The method includes receiving, by processing hardware from a core network (CN), a request to configure a common tunnel associated with an MBS session, via which the base station is to receive MBS data, from the CN, for wireless transmission to multiple user equipment (UEs); and in response to the request, transmitting, by the processing hardware to the CN, a configuration of the common tunnel.

Another example embodiment of these techniques is a method in a base station for managing transmission of MBS, the method comprising: receiving, by processing hardware from a CN, a first message indicating that a first UE has joined an MBS session; and in response to the first message, transmitting, by the processing hardware to the CN, a configuration for a tunnel via which the base station is to receive, from the CN, MBS data for the MBS session; receiving, by the processing hardware from the CN, a second message indicating that a second UE has joined the MBS session; and in response to the second message, transmitting, by the processing hardware to the CN, the configuration.

Yet another example embodiment of these techniques is a base station including processing hardware and configured to implement one of the methods above.

Another example embodiment of these techniques is a method in a CN for managing transmission of MBS, the method comprising: transmitting, by processing hardware to a base station, a request to configure a tunnel associated with an MBS session, via which the CN is to transmit MBS data to the base station for wireless transmission to multiple UEs; and receiving, by the processing hardware from the base station, a configuration of the tunnel.

Still another example embodiment of these techniques is a CN including processing hardware and configured to implement the method above.

### BRIEF DESCRIPTION OF THE DRAWINGS

FIG. 1A is a block diagram of an example system in which the techniques of this disclosure for managing transmission and reception of MBS information can be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions, respectively;

FIGS. 4A-4D are messaging diagrams of example scenarios in which a CN and a base station establish a common downlink (DL) tunnel or a UE-specific DL tunnel via which the CN can transmit MBS data of an MBS session, for one or multiple UEs, to the base station, and the base station transmits the MBS data to the one or multiple UEs via a MRB or a DRB;

FIGS. 5-7 are flow diagrams of example methods for joining one or more MBS sessions and receiving MBS data of the MBS session(s), which can be implemented in a UE of FIG. 1A;

FIGS. 8A-8C are flow diagrams of example methods for determining to configure configuration parameters for an MBS session or a PDU session, which can be implemented in a base station of FIG. 1A;

FIGS. 9A-9B are flow diagrams of example methods for configuring multiple configurations for a particular MBS session, which can be implemented in a base station of FIG. 1A; and

FIG. 10 is a flow diagram of an example method for configuring a DRB and a MRB for transmitting MBS data of an MBS session, which can be implemented in a base station of FIG. 1A.

### DETAILED DESCRIPTION OF THE DRAWINGS

Generally speaking, a RAN and/or a CN implement the techniques of this disclosure to manage transmission of multicast and/or broadcast services (MBS). A CN can request that a base station configure a common downlink (DL) tunnel via which the CN can transmit MBS data for an MBS session to the base station, for multiple UEs. In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QOS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

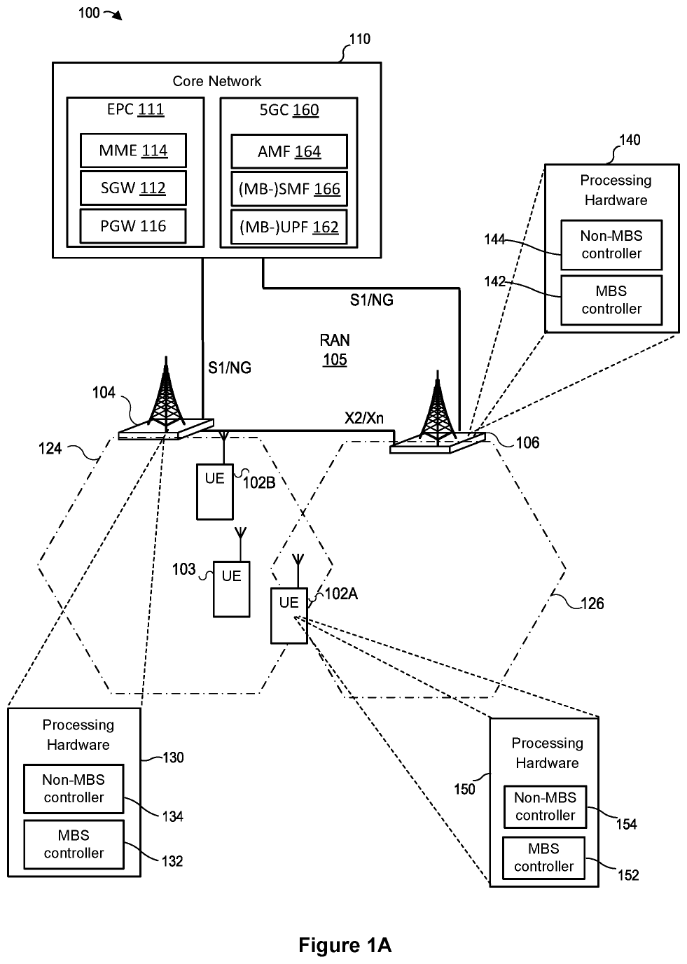

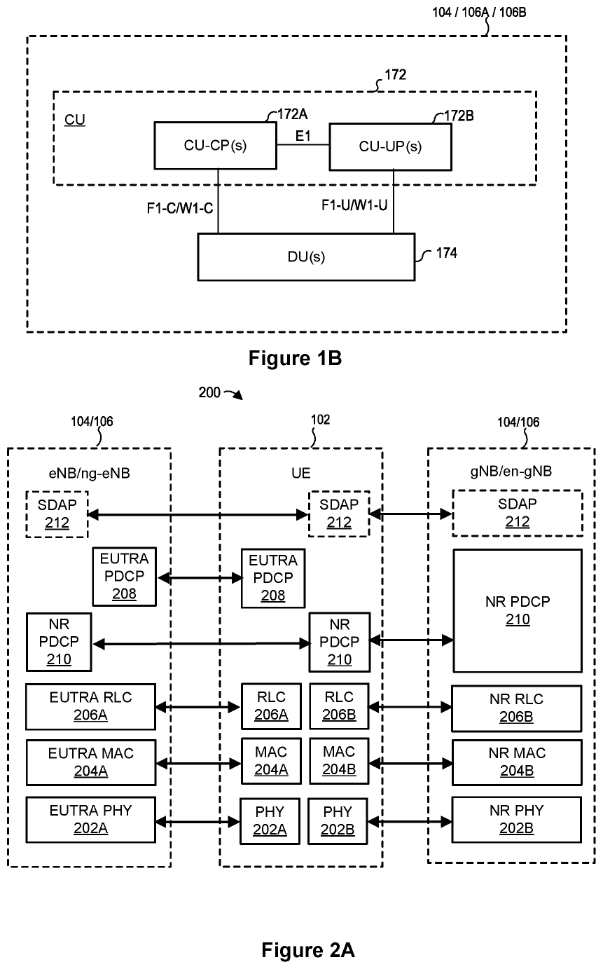

FIG. 1A depicts an example wireless communication system 100 in which techniques of this disclosure for managing transmission and reception of multicast and/or broadcast services (MBS) information can be implemented. The wireless communication system 100 includes user equipment (UEs) 102A, 102B, 103 as well as base stations 104, 106 of a radio access network (RAN) 105 connected to a core network (CN) 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows the various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB)) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UE 102B may include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of any one or more of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B, 103A and 103B.

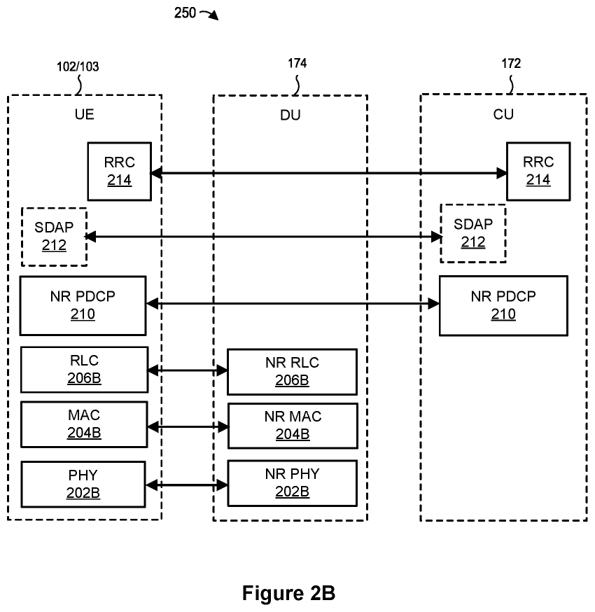

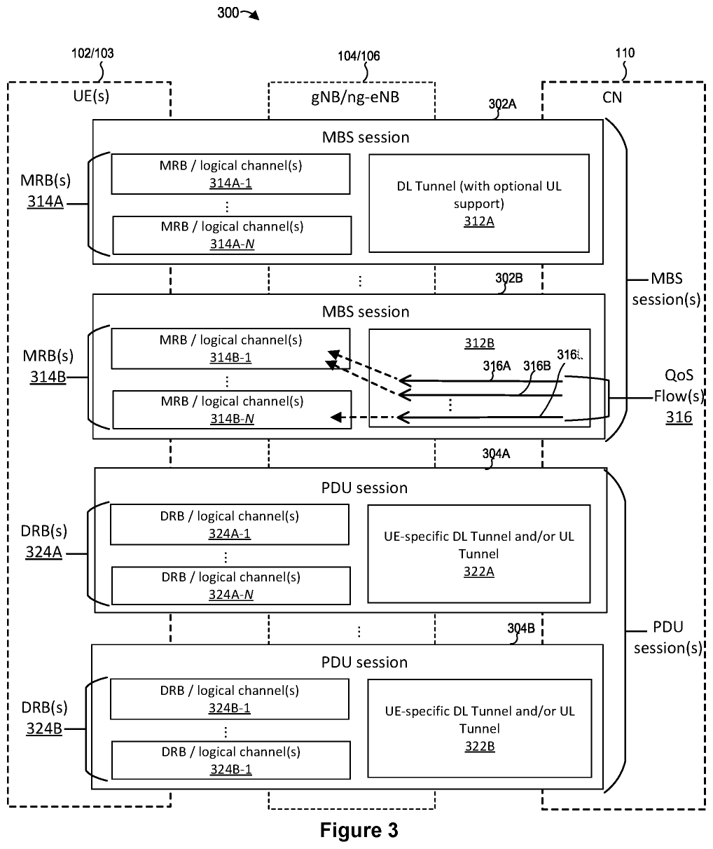

FIG. 2A illustrates, in a simplified manner, an example protocol stack 200 according to which a UE (e.g., UE 102A, 102B or 103) can communicate with an eNB/ng-eNB or a gNB (e.g., one or more of the base stations 104, 106). In the example protocol stack 200, a PHY sublayer 202A of EUTRA provides transport channels to a EUTRA MAC sublayer 204A, which in turn provides logical channels to a EUTRA RLC sublayer 206A. The EUTRA RLC sublayer 206A in turn provides RLC channels to a EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE operates in EN-DC with the base station 104 operating as an MeNB and the base station 106 operating as an SgNB, the wireless communication system 100 can provide the UE with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104, 106) broadcasts or multicasts MBS data packets via one or more MBS radio bearers (MRB(s)), and in turn the UE (e.g., the UE 102, 103) receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

Referring to FIG. 3, an MBS session 302A can include a tunnel 312A with endpoints at the CN 110 and the base station 104/106. The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, CN 110 and the base station 104/106 use the tunnel 312A for downlink as well as for uplink (UL) MBS traffic to support, for example, commands or service requests from the UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and a GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . , 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2, . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B, . . . , 316L. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2, . . . , 324-N. Each of the DRBs 324A can correspond to a respective logical channel, such as a Dedicated Traffic Channel (DTCH).

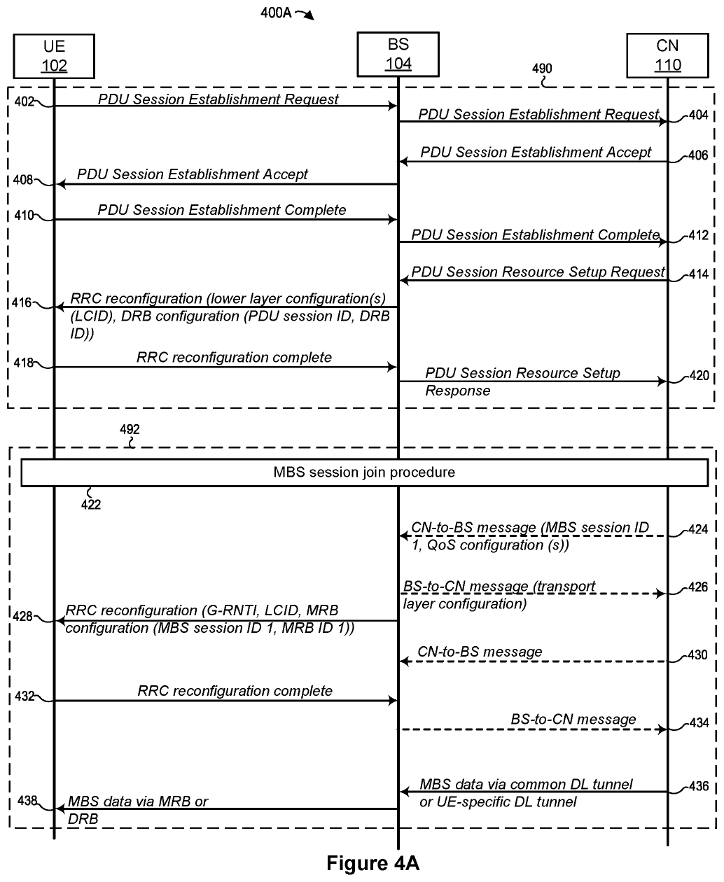

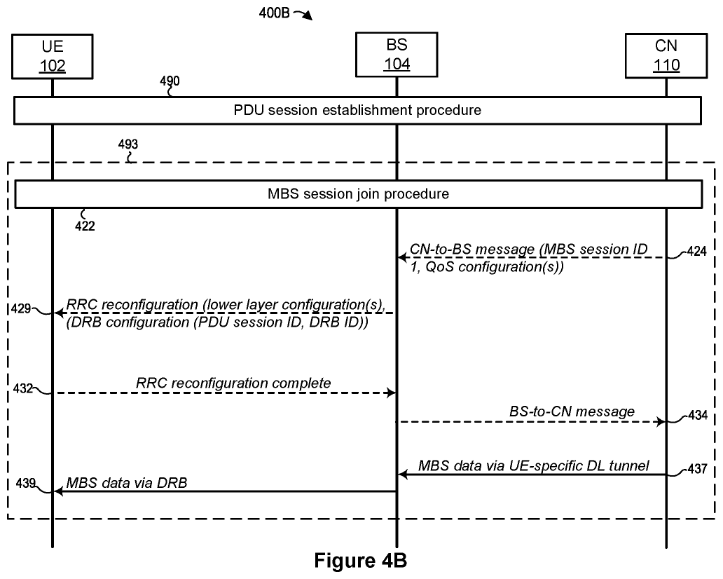

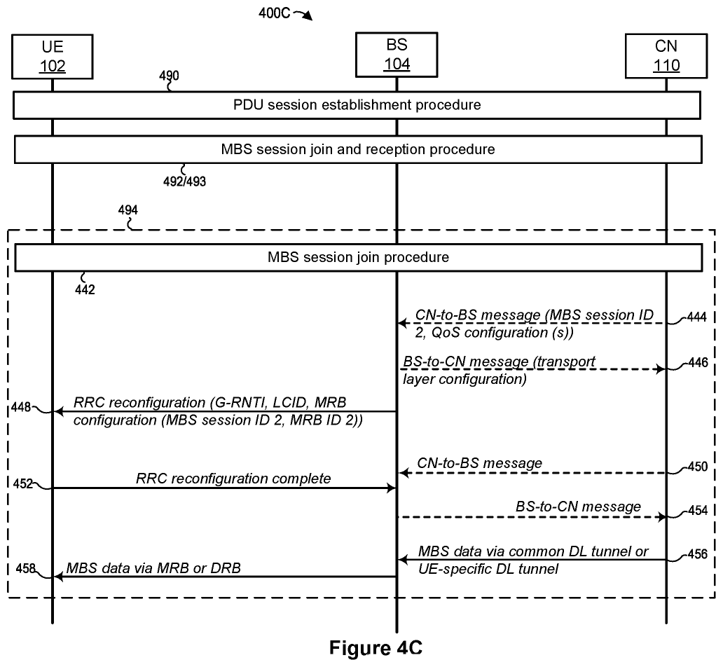

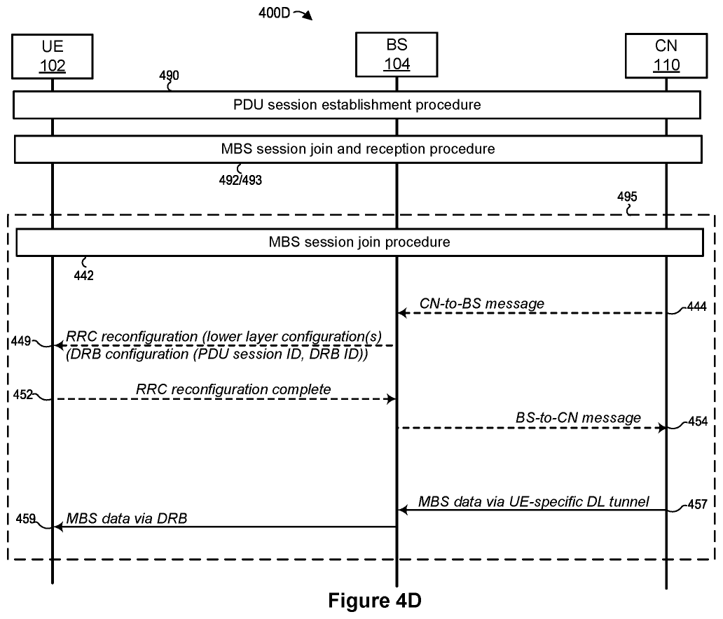

Next, FIG. 4A illustrates an example scenario 400A in which the base station (BS) 104 configures a common tunnel for MBS data in response to the CN requesting resources for an MBS session. In the following description, the UE 102 can represent the UE 102A and/or the UE 102B.

The UE 102 initially performs 490 a PDU session establishment procedure with the CN 110 via the base station 104 to establish a PDU session to receive MBS. In details, the UE 102 transmits 402 a PDIJ Session Establishment Request message to the base station 104, which in turn transmits 404 (a BS-to-CN message including) the PDU Session Establishment Request message to the CN 110. In response, the CN 110 can send 406 (a CN-to-BS message including) a PDU Session Establishment Accept message to the base station 104, which in turn transmits 408 the PDU Session Establishment Accept message to the UE 102. In response to the PDU Session Establishment Accept message, the UE 102 then transmits 410 a PDU Session Establishment Complete message to the base station 104, which in turn transmits 412 (a BS-to-CN message including) the PDU Session Establishment Complete message to the CN 110.

In some implementations, the UE 102 can generate a container message including the PDU Session Establishment Request message and transmits 402, 404 the container message to the CN 110 via the base station 104. Similarly, the CN 110 can generate a container message including the PDU Session Establishment Accept message and transmits 406, 408 the container message to the UE 102 via the base station 104. Likewise, the UE 102 can generate a container message including the PDIJ Session Establishment Complete message and transmits 410, 412 the container message to the CN 110 via the base station 104.

To simplify the following description, the PDU Session Establishment Request message, the PDU Session Establishment Accept message, the PDU Session Establishment Complete message can represent the container messages.

In some implementations, the UE 102 can include, in the PDIJ Session Establishment Request message, a PDU session ID identifying the PDU session, slice information associated with an MBS session of event 422, and/or a particular data network name (DNN) (e.g., “MBS” or “mbs”). In some implementations, the CN 110 may include the PDU session ID in the PDU Session Establishment Accept message.

In response to or after receiving 406 the message, the CN 110 can send 414 to the base station 104 a CN-to-BS message (e.g., a PDIJ Session Resource Setup Request message) to request the base station 104 to configure resources for the PDU session. In some implementations, the CN 110 can include the PDU session ID in the CN-to-BS message. In response to the CN-to-BS message, the base station 104 can send 416 to the UE 102 a RRC reconfiguration message including unicast configuration parameters. In response, the UE transmits 418 a RRC reconfiguration complete message to the base station 104. The base station 104 can transmit 420 a BS-to-CN message (e.g., a PDU Session Resource Setup Response message) to the CN 110 after or before receiving 420 the RRC reconfiguration complete message. In some implementations, the CN 110 can include, in the CN-to-BS message 406 or 414, a UL transport layer configuration configuring a UE-specific UL tunnel for the PDU session with the UE 102. Alternatively, the CN 110 refrains from configuring a UE-specific UL tunnel for the PDU session with the UE 102. The UL transport layer configuration includes a transport layer address (e.g., an IP address) and/or a TEID to identify the UE-specific UL tunnel. In some implementations, the base station 104 can include, in the BS-to-CN message 412 or 420 a DL transport layer configuration configuring a UE-specific DL tunnel for the PDU session with the UE 102. The DL transport layer configuration includes a transport layer address (e.g., an IP address) and/or a TEID to identify the UE-specific DL tunnel.

In some implementations, the CN-to-BS message of the event 406 and the CN-to-BS message of the event 414 can be combined as a single CN-to-BS message. For example, the CN 110 can include the PDIJ Session Establishment Accept message in the CN-to-BS message of the event 414 and the event 406 is omitted. In some implementations, the base station 104 can include the PDU Session Establishment Accept message in the RRC reconfiguration message 416 or transmit the PDIJ Session Establishment Accept message after transmitting 416 the RRC reconfiguration message. In such cases, the UE 102 can include the PDIJ Session Establishment Complete message in the RRC reconfiguration complete message 418 or transmit the PDIJ Session Establishment Complete message before or after transmitting 418 the RRC reconfiguration complete message. In some implementations, the base station 104 can include the PDU Session Establishment Complete message in the BS-to-CN message of the event 420.

In some implementations, the unicast configuration parameters can include a (first) DRB configuration (e.g., a DRB-ToAddMod IE) and first lower layer configuration(s). The DRB configuration configures a (first) DRB. The DRB configuration includes a DRB ID (e.g., drb-Identity or DRB-Identity) identifying the DRB, and includes the PDU session ID to indicate that the DRB (ID) associated with the PDU session (ID). The DRB configuration can also include a PDCP configuration and/or a SDAP configuration.

In some implementations, the (first) lower layer configuration(s) are associated with the DRB configuration. The lower layer configuration(s) include a (first) logical channel identity (ID) (e.g., LogicalChannelIdentity IE) identifying a logical channel (e.g., a dedicated traffic channel (DTCH)), a RLC configuration (e.g., RLC-Config IE) and/or a logical channel configuration (e.g., LogicalChannelConfig IE). In some implementations, the base station 104 can exclude the logical channel configuration from the RRC reconfiguration message 416. In some implementations, the lower layer configuration can be or include a RLC bearer configuration (e.g., RLC-BearerConfig IE), which can include the DRB ID, the logical channel ID, the RLC configuration and/or the logical channel configuration. In some implementations, the lower configuration can be a cell group configuration (e.g., CellGroupConfig IE). In some implementations, the lower layer configuration includes a MAC configuration (e.g., MAC-CellGroupConfig IE) or a physical layer configuration (e.g., PhysicalCellGroupConfig IE).

After performing 490 the PDU session establishment procedure, the UE 102 performs 422 an MBS session join procedure with the CN 110 via the base station 104 to join a certain MBS session (e.g., a first MBS session). To perform the MBS session join procedure, the UE 102 in some implementations sends an MBS session join request message to the base station 104, which in turn transmits the MBS session join request message to the CN 110. In response, the CN 110 can send an MBS session join response message to the UE 102 via the base station 104 to grant the UE 102 access to the MBS session. In some implementations, the UE 102 can include a (first) MBS session ID of the MBS session in the MBS session join request message. The CN 110 in some cases includes the MBS session ID in the MBS session join response message. In some implementations, the UE 102 can send an MBS session join complete message to the CN 110 via the base station 104 in response to the MBS session join response message. In some implementations, the UE 102 may include the MBS session ID in the PDU Session Establishment Request message or the PDU Session Establishment Accept message.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDIJ Session Modification Request message, a PDI Session Modification Command message, and a PDU Session Modification Complete message, respectively. To simplify the following description, the MBS session join request message, the MBS session join response message, and/or the MBS session join complete message can represent the container messages.

During the MBS session join procedure, the UE 102 can communicate the PDU session ID with the CN 110 via the base station 104. For example, the UE 102 can include the PDU session ID in the MBS session join request message or the MBS session join complete message, and/or the CN 110 can include the PDU session ID in the MBS session join accept message. In some implementations, the PDU session IDs of the UE 102A and UE 102B can be the same (value). In other implementations, the PDU session IDs of the UE 102A and UE 102B can be the different (values).

Before, during, or after the MBS session join procedure (event 422), the CN 110 can send 424 a (first) CN-to-BS message including the MBS session ID and/or the PDU session ID to the base station 104 to request the base station 104 to configure resources for the MBS session. The CN 110 can additionally include, in the CN-to-BS message, quality of service (QOS) configuration(s) for the MBS session. In response, the base station 104 can (determine to) send 426 a (first) BS-to-CN message including a DL transport layer configuration to configure a common DL tunnel for the CN 110 to send MBS data to the base station 104. The DL transport layer configuration includes a transport layer address (e.g., an IP address) and/or a TEID to identify the common DL tunnel. The base station 104 can include the MBS session ID and/or the PDU session ID in the BS-to-CN message. In cases where the base station 104 has configured a common DL tunnel has for the MBS session before receiving the BS-to-CN message, the base station 104 determines not to send the BS-to-CN message. That is, the base station 104 refrains from sending the BS-to-CN message in such cases.

In some implementations, the CN-to-BS message of event 424 can be a generic NGAP message or a dedicated NGAP message defined specifically for requesting resources for an MBS session (e.g., MBS Session Resource Setup Request message). In some implementations, the BS-to-CN message of event 426 is a generic NGAP message or a dedicated NGAP message defined specifically to convey resources for an MBS session (e.g., MBS Session Resource Setup Response message). In such cases, the CN-to-BS message of event 424 and the BS-to-CN message of event 426 can be non-UE-specific messages.

In some implementations, the CN 110 can indicate, in the CN-to-BS message of event 424, a list of UEs joining the MBS session. In other implementations, the CN 110 can send 430 to the base station 104 a second CN-to-BS message indicating a list of UEs joining the MBS session. The CN 110 can include the MBS session ID and/or the PDU session ID in the second CN-to-BS message. The base station 104 can send 434 a second BS-to-CN message to the CN 110 in response to the second CN-to-BS message 430. In such cases, the second CN-to-BS message and the second BS-to-CN message can be non-UE-specific messages. For example, the list of UEs includes the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be an “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In some alternative implementations, the CN 110 can send 430 to the base station 104 another, second CN-to-BS message indicating that the UE 102 (e.g., a single UE such as UE 102A or UE 102B) joins the first MBS session. The base station 104 can send 430 another, second BS-to-CN message to the CN 110 in response to the second CN-to-BS message 408. In such cases, the CN 110 can include the MBS session join response message for the UE 102 in the second CN-to-BS message. The base station 104 can include a first CN UE interface ID and a first RAN UE interface ID, identifying the UE 102, in the second CN-to-BS message. In some implementations, the second CN-to-BS message and the second BS-to-CN message can be UE-specific NGAP messages, such as a PDU Session Resource Modify Request message and a PDU Session Resource Modify Response message, respectively.

In other implementations, the first CN-to-BS message can be a UE-specific NGAP message (e.g., PDU Session Resource Modify Request message) indicating that the UE 102 (e.g., a single UE such as UE 102A or UE 102B) joins the MBS session. The CN 110 can include the MBS session join response message for the UE 102 in the first CN-to-BS message. The base station 104 can include a first CN UE interface ID and a first RAN UE interface ID, identifying the UE 102, in the first CN-to-BS message. In some implementations, the first BS-to-CN message can be a generic NGAP message or a dedicated NGAP message defined specifically to convey resources for an MBS session (e.g., MBS Session Resource Setup Indication message or RAN Configuration Update message). In such cases, the CN 110 can send 430 another, second CN-to-BS message (e.g., MBS Session Resource Setup Confirm message or RAN Configuration Update Acknowledge message) to the base station 104 in response to the first BS-to-CN message. The base station 104 can send 414 to the CN 110 a second BS-to-CN message (e.g., PDU Session Resource Modify Response message) in response to the first CN-to-BS message.

In some implementations, the CN 110 can include the MBS session join response message for the UE 102 in another CN-to-BS message instead of the first CN-to-BS message or the second CN-to-BS message.

In some implementations, the QoS configuration(s) include QoS parameters for the MBS session. In some implementations, the QoS configuration includes configuration parameters to configure one or more QoS flows for the MBS session (see FIG. 3). In some implementations, the configuration parameters include one or more QoS flow IDs identifying the QoS flow(s). Each of the QoS flow ID(s) identifies a particular QOS flow of the QoS flow(s). In some implementations, the configuration parameters include QoS parameters for each QoS flow. The QoS parameters can include a 5G QoS identifier (5Q1), a priority level, packet delay budget, packet error rate, averaging window, and/or a maximum data burst volume. The CN 110 can specify different values of the QoS parameters for the QoS flows.

In cases where the base station 104 establishes the common DL tunnel for the MBS session as described above, the base station 104 may refrain from including a DL transport layer configuration for the MBS session in the second BS-to-CN message. In such cases, the CN 110 may refrain from including a UL transport layer configuration for the MBS session in the first CN-to-BS message and/or second CN-to-BS message.

After or in response to receiving 424 the first CN-to-BS message or 430 the second CN-to-BS message or transmitting 426 the first BS-to-CN message, the base station 104 generates RRC reconfiguration message(s) (e.g., RRCReconfiguration message(s)) including MBS configuration parameters for the UE 102 to receive MBS data of the MBS session. The base station 104 then transmits 428 the RRC reconfiguration message to the UE 102. In response, the UE 102 transmits 432 an RRC reconfiguration complete message(s) (e.g., RR (ReconfigurationComplete message(s)) to the base station 104. The base station 104 can send 434 the second BS-to-CN message to the CN 110 before or after receiving 432 the RRC reconfiguration complete message.

In some implementations, the MBS configuration parameters can include one or more MRB configuration and/or one or more RLC bearer configurations each associated with a particular MRB. Each of the MRB configuration(s) can include a (first) MRB ID (e.g., MRB ID 1), a PDCP configuration, the MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel (e.g., an MBS traffic channel (MTCH)). In some implementations, the configuration parameters or the MRB configuration may include logical channel configuration (e.g., LogicalChannelConfig IE) configuring the logical channel. In some implementations, the RLC bearer configuration may include the MRB ID. In some implementations, the base station 104 can set the MRB ID to the same value as the DRB ID of event 416. Thus, the UE 102 and base station 104 can associate the MRB with the DRB or the PDU session. In other implementations, the base station 104 can set the MRB ID to a different value from the DRB ID of event 416. As the UE 102 associates the MBS session (ID) with the PDU session (ID), the UE 102 can associate the MRB (ID) with the MBS session (ID) in accordance with the MRB configuration and identify that the MRB (ID) is associated with the DRB (ID).

In some implementations, the UE 102 can perform an MBS session leave procedure with the CN 110 via the base station 104 to leave the MBS session. In the MBS session leave procedure, the UE 102 send an MBS session leave request message to the CN 110 via the base station 104 to leave the MBS session. In response, the CN 110 sends an MBS session leave response message to the UE 102 via the base station 104. In response to the MBS session leave response message, the UE 102 may send an MBS session leave complete message to the CN 110 via the base station 104. For example, the MBS session leave request message, the MBS session leave response message and/or the MBS session leave complete message can be SIP messages. In another example, the MBS session leave request message, the MBS session leave response message and/or the MBS session leave complete message can be a PDU Session Modification Request message, a PDU Session Modification Command message, and/or a PDU Session Modification Complete message, respectively. In some implementations, the MBS session leave request message, the MBS session leave response message and/or the MBS session leave complete message can be included in separate container messages as described for the MBS session join procedure above. To simplify the following description, the MBS session leave request message, the MBS session leave response message, and/or the MBS session join complete message can represent the container messages. The UE 102 can include the MBS session ID and/or the PDU session ID in the MBS session leave request message. The CN 110 can include the MBS session ID and/or the PDU session ID in the MBS session leave response message to grant the UE to leave the MBS session. In cases where the UE 102 joins the MBS session and other MBS session(s), the UE 102 can include MBS session ID(s) of the other MBS session(s) in the MBS session leave request message. Thus, the UE performs a single MBS session procedure with the CN 110 via the base station 104 to release all the MBS sessions that the UE 102 joins.

In some implementations, the CN 110 can initiates releasing the MBS session by transmitting the MBS session leave response message including the MBS session ID to the UE 102 via the base station 104. In response, the UE 102 releases the MBS session and sends the MBS session leave complete message to the CN 110 via the base station 104.

In some implementations, the UE 102 can perform a PDU session release procedure with the CN 110 to simultaneously release the PDU session and all the MBS session(s) associated to the PDU session, without performing an MBS session release procedure. In the PDU session release procedure, the UE 102 can send, a PDIJ Session Release Request message including the PDU session ID to the CN 110 via the base station 104. In response, the CN 110 can send a PDIJ Session Release Command message to the UE 102. In response to the PDU Session Release Command message, the UE 102 releases the PDU session and all the MBS sessions) and can send a PDU Session Release Complete message to the base station 104. In some implementations, the PDU Session Release Request message, the PDU Session Release Command message and/or the PDU Session Release Complete message can be included in separate container messages as described for the PDU session establishment procedure above. To simplify the following description, the PDI Session Release Request message, the PDU Session Release Command message, and/or the PDU Session Release Complete message can represent the container messages.

In some implementations, the UE 102 may not include the MBS session ID(s) in the PDU Session Release Request message. In other implementations, the UE may include the MBS session ID(s) in the PDU Session Release Request message. The CN 110 may or may not include the PDU session ID and/or MBS session ID(s) in the PDU Session Release Command message. In some implementations, the CN 110 can initiate releasing the PDU session by transmitting the PDIJ Session Release Command message including the PDU session ID to the UE 102 via the base station 104. In response, the UE 102 releases the PDU session and the MBS session(s) and sends the PDIJ Session Release Complete message to the CN 110 via the base station 104. In such implementations, the CN 1102 may or may not include the MBS session ID(s) in the PDU Session Release Command message.

In some implementations, the base station 104 can configure the MRB as a DL-only RB in the MRB configuration. For example, the base station 104 can refrain from including UL configuration parameters in the PDCP configuration within the MBR configuration to configure the MRB as a DL-only RB. The base station 104 can include only DL configuration parameters in the MRB configuration, e.g., as described above. In such cases, the base station 104 configures the UE 102 to not transmit UL PDCP data PDU via the MRB to the base station 104 by excluding the UL configuration parameters for the MRB in the PDCP configuration in the MBR configuration. In another example, the base station 104 refrains from including UL configuration parameters in the RLC bearer configuration. In such cases, the base station 104 configures the UE 102 not to transmit the control PDU(s) via the logical channel to the base station 104 by excluding the UL configuration parameters from the RLC bearer configuration.

In cases where the base station 104 includes UL configuration parameter(s) in the RLC bearer configuration, the UE 102 may transmit control PDU(s) (e.g., PDCP Control PDU(s) and/or RLC Control PDU(s)) via the logical channel to the base station 104 using the UL configuration parameter(s). For example, the base station 104 may configure the UE to receive MBS data with a (de)compression protocol (e.g., robust header compression (ROHC) protocol). In this case, when the base station 104 receives 416 an MBS data packet from the CN 110, the base station 104 compresses the MBS data packet with the compression protocol to obtain compressed MBS data packet(s) and transmits 418 a PDCP PDU including the compressed MBS data packet to the UE 102. When the UE 102 receives the compressed MBS data packet(s), the UE 102 decompresses the compressed MBS data packet(s) with the (de)compression protocol to obtain the original MBS data packet. In such cases, the UE 102 may transmit a PDCP Control PDU including, a header compression protocol feedback (e.g., interspersed ROHC feedback) for operation of the header (de)compression protocol, via the logical channel to the base station 104.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the base station 104 has configured DRB(s) to the UE 102 for unicast data communication, the base station 104 in some implementations can set the MRB ID(s) to values different from DRB ID(s) of the DRB(s). In such cases, the UE 102 and the base station 104 can distinguish whether an RB is an MRB or a DRB in accordance an RB ID of the RB. In other implementations, the base station 104 can set one or more of the MRB ID(s) to values which can be the same as one or more of the DRB ID(s). In such cases, the UE 102 and the base station 104 can distinguish whether an RB is an MRB or a DRB in accordance an RB ID of the RB and an RRC IE configuring the RB.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters might or might not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the base station 104 can include the MBS session join response message in the RRC reconfiguration message the base station 104 transmits 428 to the UE 102. The UE 102 can include the MBS session join complete message in the RRC reconfiguration complete message of event 432. Alternatively, the UE 102 can send a UL RRC message including the MBS session join complete message to the base station 104. The UL RRC message can be a ULInformationTransfer message or any suitable RRC message that can include a UL NAS PDU. The base station 104 can include the MBS session join complete message in the second BS-to-CN message. Alternatively, the base station 104 can send the CN 110 a BS-to-CN message (e.g., an UPLINK NAS TRANSPORT message) including the MBS session join complete r message to the CN 110.

In other implementations, the base station 104 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the base station 104. The UL RRC message can be a ULInformationTransfer message, another RRC reconfiguration complete message or any suitable RRC message that can include a UL NAS PDU.

After receiving 426 the first BS-to-CN message or receiving 434 the second BS-to-CN message, the CN 110 can send 436 MBS data via the UE-specific DL tunnel and/or the common DL tunnel to the base station 104, which in turn transmits (e.g., multicast or unicast) 438 the MBS data via the MRB or DRB (i.e., via the one or more logical channels associated with the MRB or DRB) to the UE 102. In some cases the CN 110 can send 436 MBS data via the UE-specific DL tunnel to the base station 104, which in turn transmits (e.g., multicast or unicast) 438 the MBS data via the DRB (i.e., via the logical channel associated with the DRB) to the UE 102. In some cases the CN 110 can send 436 MBS data via the common DL tunnel to the base station 104, which in turn transmits (e.g., multicast or unicast) 438 the MBS data via the MRB (i.e., via the logical channel(s) associated with the MRB) to the UE 102.

The UE 102 receives 438 the MBS data via the one or more logical channels. For example, the base station 104 receives 436 an MBS data packet from the CN 110, generates a PDCP PDU including the MBS data packet in accordance with the PDCP configuration within the MRB configuration, generates a MAC PDU including the logical channel ID and the PDCP PDU, and transmits 438 the MAC PDU to the UE 102 via unicast or multicast. The UE 102 receives 438 the MAC PDU, retrieves the PDCP PDU and the logical channel ID from the MAC PDU, identifies the PDCP PDU associated with the MRB or DRB in accordance with the logical channel ID, and retrieves the MBS data packet from the PDCP PDU in accordance with the PDCP configuration within the MRB configuration or DRB configuration. More specifically, if the logical channel ID is associated with the DRB, the UE 102 retrieves the MBS data packet from the PDCP PDU in accordance with the PDCP configuration within the DRB configuration. if the logical channel ID is associated with the MRB, the UE 102 retrieves the MBS data packet from the PDCP PDU in accordance with the PDCP configuration within the MRB configuration

The events 422, 424, 426, 428, 430, 432, 434, 436 and 438 are collectively referred to in FIG. 4A as an MBS session join and reception procedure 492.

As illustrated in FIG. 3, the base station 104 can map data packets of a particular MBS session via a particular common DL tunnel to one or more MRBs, each corresponding to a respective logical channel. As described above, the base station 104 at event 426 configures the common DL tunnel, and the base station 104 at event 428 configures the MRB(s) (ID(s)) for the MBS session (ID) and configures the logical channel(s) (ID(s)) for (each of) the MRB(s) (ID(s)). Thus, the base station 104 can map data packets of the MBS session via the common DL tunnel to the MRB(s), each corresponding to a respective logical channel.

Referring next to FIG. 4B, a scenario 400B is depicted which is generally similar to the scenario 400A. Events in this scenario similar to those discussed above are labeled with the same reference numbers and the examples and implementations for FIG. 4A can apply to FIG. 4B. The differences between the scenarios of FIG. 4A and FIG. 4B are discussed below.

In some implementations, the CN 110 may or may not transmit 424 the CN-to-BS message, e.g., in response to or after receiving the MBS session join request message of the MBS session join procedure 422. In cases where the CN 110 transmits 424 the CN-to-BS message to the base station 104, the base station 104 can transmit 429 to the UE 102 a RRC reconfiguration message including unicast configuration parameters instead of the MBS configuration parameters, instead of the event 428. In such cases, the base station 104 may not configure a common DL tunnel for the MBS session. In some implementations, the base station 104 can include, in the BS-to-CN message 434, a DL transport layer configuration configuring a UE-specific DL tunnel. The DL transport layer configuration can include a transport layer address (e.g., IP address) and/or a TEID to identify the UE specific DL tunnel. In such cases, the CN 110 may or may include, in the CN-to-BS message 424, a UL transport layer configuration configuring a UE-specific UL tunnel.

In some implementations, the base station 104 can generate the unicast configuration parameters of the event 429, to update the unicast configuration parameters of the event 416 and/or to configure a (second) DRB.

In some implementations, the unicast configuration parameters can include a (second) DRB configuration (e.g., a DRB-ToAddMod IE) and first lower layer configuration(s). The DRB configuration configures the (second) DRB. The DRB configuration includes a (second) DRB ID (e.g., drb-Identity or DRB-Identity) identifying the DRB, and includes the PDU session ID to indicate that the DRB (ID) associated with the PDU session (ID). The DRB configuration can also include a PDCP configuration and/or a SDAP configuration.

In some implementations, the (second) lower layer configuration(s) are associated with the DRB configuration. The lower layer configuration(s) include a (second) logical channel identity (ID) (e.g., LogicalChannelIdentity IE) identifying a logical channel (e.g., a DTCH), a RLC configuration (e.g., RLC-Config IE) and/or a logical channel configuration (e.g., LogicalChannelConfig IE). In some implementations, the base station 104 can exclude the logical channel configuration from the RRC reconfiguration message 416. In some implementations, the lower layer configuration can be or include a RLC bearer configuration (e.g., RLC-BearerConfig IE), which can include the DRB ID, the logical channel ID, the RLC configuration and/or the logical channel configuration. In some implementations, the lower configuration can be a cell group configuration (e.g., CellGroupConfig IE). In some implementations, the lower layer configuration includes a MAC configuration (e.g., MAC-CellGroupConfig IE) or a physical layer configuration (e.g., PhysicalCellGroupConfig IE).

In some implementations, (some of) the unicast configuration parameters of the event 429 and (some of) the unicast configuration parameters of the event 428 may have the same values. In other implementations, (some of) the unicast configuration parameters of the event 429 and (some of) the unicast configuration parameters of the event 428 may have different values.

Alternatively, the base station 104 refrains from transmitting 429 the RRC reconfiguration message to the UE 102 and the event 432 is omitted.

After receiving 434 the BS-to-CN message, the CN 110 can send 437 MBS data via the UE-specific DL tunnel (i.e., configured in the BS-to-CN message 434) to the base station 104, which in turn transmits the MBS data via the second DRB (i.e., via the logical channel associated with the second DRB). After receiving 434 the BS-to-CN message, the CN 110 can send 437 MBS data via the UE-specific DL tunnel (i.e., configured in the event 420) to the base station 104, which in turn transmits (i.e., unicast) the MBS data via the first DRB (i.e., via the logical channel associated with the first DRB).

As illustrated in FIG. 3, the base station 104 can map data packets of a particular MBS session via a particular UE-specific DL tunnel to one or more DRBs, each corresponding to a respective logical channel. As described above, the base station 104 at event 434 configures the UE-specific DL tunnel, and the base station 104 at events 490, 429 configures the DRB(s) (ID(s)) for the MBS session (ID) and configures the logical channel(s) (ID(s)) for (each of) the DRB(s) (ID(s)). Thus, the base station 104 can map data packets of the MBS session via the UE-specific DL tunnel to the first DRB and/or second DRB, each corresponding to a respective logical channel.

The events 422, 424, 429, 434, 437 and 439 are collectively referred to in FIG. 4B as an MBS session join and reception procedure 493.

Referring next to FIG. 4C, a scenario 400C is depicted which is generally similar to the scenarios 400A and 400B. Events in this scenario similar to those discussed above are labeled with the same reference numbers and the examples and implementations for FIGS. 4A and 4B can apply to FIG. 4C. The differences among the scenarios of FIGS. 4A-4C are discussed below.

The CN 110, base station 104 and UE 102 can perform 494 MBS session join and reception procedure for a second MBS session, similar to the procedure 492. Events, 444, 446, 448, 450, 452, 454, 456 and 458 are similar to events 424, 426, 428, 430, 432, 434, 436 and 438, respectively. A DL transport layer configuration of the event 426 can configure a common DL tunnel for the second MBS session. More specifically, the DL transport layer configuration includes a transport layer address (e.g., IP address) and/or a TEID to identifying the common DL tunnel. A RRC reconfiguration message of the event 448 includes MBS configuration parameters similar to the MBS configuration parameters of the event 428. (Some of) the MBS configuration parameters of the event 448 and (some of) the MBS configuration parameters of the event 428 may have different values. For example, the MBS configuration parameters of the event 428 includes a MRB configuration configuring or including the second MBS session ID, a second MRB (ID) (e.g., MRB ID 2) and a PDCP configuration, and includes a logical channel (ID) associated with the second MRB (ID).

After receiving 446 the BS-to-CN message or receiving 454 the BS-to-CN message, the CN 110 can send 456 MBS data to the base station 104 via the UE-specific DL tunnel and/or the common DL tunnel, which in turn transmits (e.g., multicast or unicast) 458 the MBS data via the MRB (i.e., via the one or more logical channels associated with the MRB) to the UE 102. The UE 102 receives 458 the MBS data via the one or more logical channels. For example, the base station 104 receives 456 an MBS data packet from the CN 110, generates a PDCP PDU including the MBS data packet in accordance with the PDCP configuration within the MRB configuration, generates a MAC PDU including the logical channel ID and the PDCP PDU, and transmits 458 the MAC PDU to the UE 102. The UE 102 receives 458 the MAC PDU, retrieves the PDCP PDU and the logical channel ID from the MAC PDU, identifies the PDCP PDU associated with the MRB in accordance with the logical channel ID, and retrieves the MBS data packet from the PDCP PDU in accordance with the PDCP configuration within the MRB configuration.

Referring next to FIG. 4D, a scenario 400D is depicted which is generally similar to the scenarios 400A 400B, and 400C. Events in this scenario similar to those discussed above are labeled with the same reference numbers and the examples and implementations for FIGS. 4A-4C can apply to FIG. 4D. The differences among the scenarios of FIGS. 4A-4D are discussed below.

The CN 110, base station 104 and UE 102 can perform 495 MBS session join and reception procedure for a second MBS session, similar to the procedure 493. Events, 444, 449, 452, 454, 456 and 458 are similar to events 424, 429, 432, 434, 436 and 438, respectively. A DL transport layer configuration of the event 454 can configure a UE-specific DL tunnel for the second MBS session. More specifically, the DL transport layer configuration includes a transport layer address (e.g., IP address) and/or a TEID to identifying the UE-specific DL tunnel. A RRC reconfiguration message of the event 449 includes unicast configuration parameters similar to the unicast configuration parameters of the event 429. (Some of) the unicast configuration parameters of the event 449 and (some of) the unicast configuration parameters of the event 429 may have different values. For example, the unicast configuration parameters of the event 429 includes a DRB configuration configuring or including the PDU session ID, a third DRB (ID) and a PDCP configuration, and includes a logical channel (ID) associated with the third DRB (ID).

After receiving 454 the BS-to-CN message, the CN 110 can send 457 MBS data to the base station 104 via the UE-specific DL tunnel, which in turn transmits (e.g., unicast) 459 the MBS data via a third DRB (i.e., via the logical channel associated with the third DRB) to the UE 102. The UE 102 receives 459 the MBS data via the logical channel. For example, the base station 104 receives 457 an MBS data packet from the CN 110, generates a PDCP PDU including the MBS data packet in accordance with the PDCP configuration within the DRB configuration, generates a MAC PDU including the logical channel ID and the PDCP PDU, and transmits 459 the MAC PDU to the UE 102 via unicast. The UE 102 receives 458 the MAC PDU, retrieves the PDCP PDU and the logical channel ID from the MAC PDU, identifies the PDCP PDU associated with the third DRB in accordance with the logical channel ID, and retrieves the MBS data packet from the PDCP PDU in accordance with the PDCP configuration within the DRB configuration.

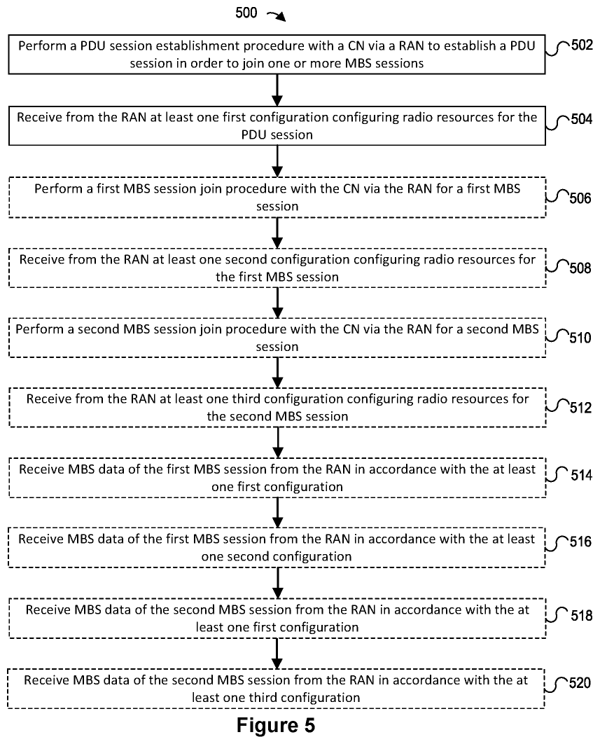

Next, several example scenarios which devices illustrated in FIGS. 1A can implement are discussed with reference to FIGS. 5-10. Each of these methods can be implemented as a set of instructions stored on a non-transitory computer-readable medium and executable by one or more processors. Blocks with dashed line can be optional.

Referring first to FIG. 5, a UE such as the UE 102A can implement a method 500 to receive MBS data.

The method 500 begins at block 502, where the UE performs a PDU session establishment procedure with a CN via a RAN to establish a PDU session in order to join one or more MBS sessions (e.g., event 490). At block 504, the UE receives from the RAN at least one first configuration configuring radio resources for the PDU session (e.g., event 416). At block 506, the UE performs a first MBS session join procedure with the CN via the RAN for a first MBS session (e.g., event 422). At block 508, the UE receives from the RAN at least one second configuration configuring radio resources for the first MBS session (e.g., events 428, 429). At block 510, the UE performs a second MBS session procedure with the CN via the RAN for a second MBS session (e.g., events 442). At block 512, the UE receives from the RAN at least one third configuration configuring radio resources for the second MBS session (e.g., events 448, 449). At block 514, the UE receives MBS data of the first MBS session from the RAN in accordance with the at least one first configuration (e.g., event 438, 439). At block 516, the UE receives MBS data of the first MBS session from the RAN in accordance with the at least one second configuration (e.g., events 438, 439). At block 518, the UE receives MBS data of the second MBS session from the RAN in accordance with the at least one first configuration (e.g., events 458, 459). At block 520, the UE receives MBS data of the second MBS session from the RAN in accordance with the at least one third configuration (e.g., events 458, 459).

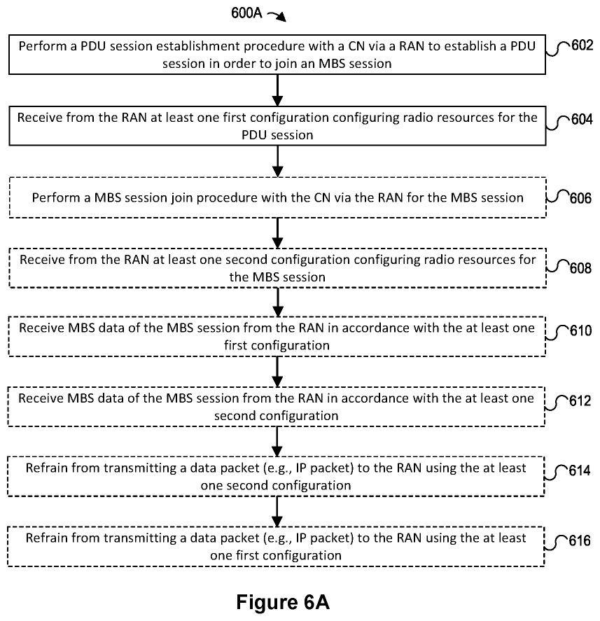

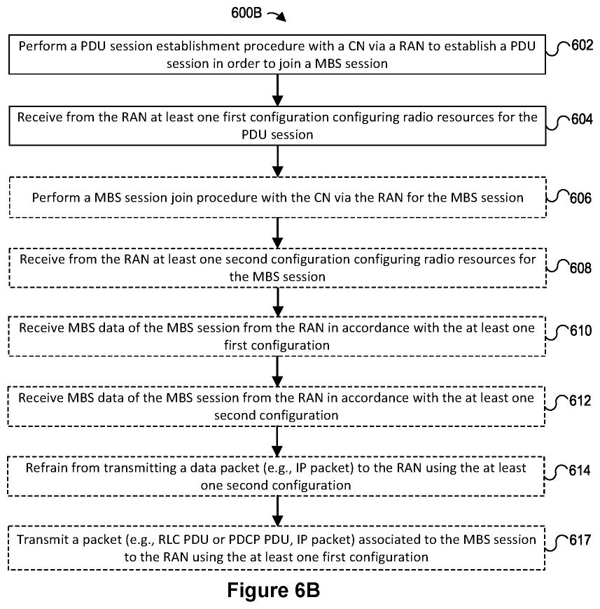

Referring next to FIG. 6A, a UE such as the UE 102A can implement a method 600A to receive MBS data.

The method 600A begins at block 602, where the UE performs a PDU session establishment procedure with a CN via a RAN to establish a PDU session in order to join an MBS session (e.g., event 490). At block 604, the UE receives from the RAN at least one first configuration configuring radio resources for the PDU session (e.g., event 416). At block 606, the UE performs an MBS session join procedure with the CN via the RAN for the MBS session (e.g., events 422, 442). At block 608, the UE receives from the RAN at least one second configuration configuring radio resources for the MBS session (e.g., events 428, 429, 448, 449). At block 610, the UE receives MBS data of the MBS session from the RAN in accordance with the at least one first configuration (e.g., events 438, 439, 458, 459). At block 612, the UE receives MBS data of the MBS session from the RAN in accordance with the at least one second configuration (e.g., events 438, 439, 458, 459). At block 614, the UE refrains from transmitting a data packet (e.g., IP packet) to the RAN using the at least one second configuration. At block 616, the UE refrains from transmitting a data packet (e.g., IP packet) to the RAN using the at least one first configuration. The data packet may or may not associated with the MBS session.

FIG. 6B is a flow diagram of an example method 600B, similar to FIG. 6A, except that the method 600B includes block 617 instead of block 616. At block 617, the UE transmits a packet (e.g., RLC PDU or PDCP PDU, IP packet) associated to the MBS session to the RAN using the at least one first configuration. In some implementations, the UE refrains from transmitting a packet not associated to the MBS session to the RAN using the at least one first configuration.

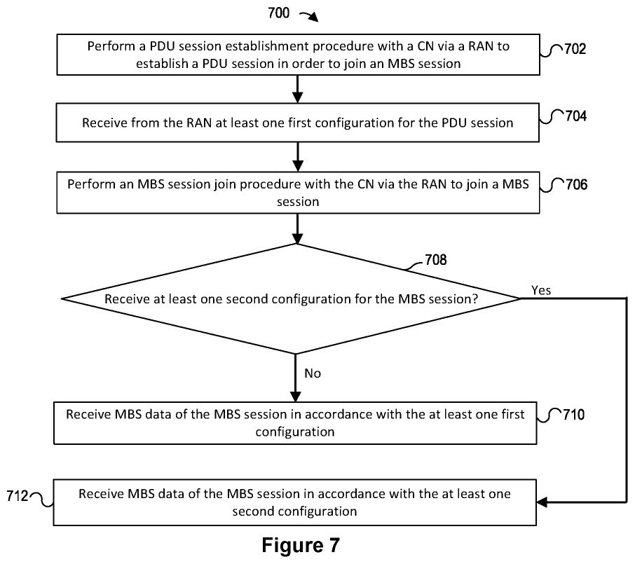

Now referring to FIG. 7, a UE such as the UE 102A can implement a method 700 to receive MBS data. The method 700 begins at block 702, where the UE performs a PDU session establishment procedure with a CN via a RAN to establish a PDU session in order to join an MBS session (e.g., event 490). At block 704, the UE receives from the RAN at least one first configuration for the PDU session (e.g., event 416). At block 706, the UE performs an MBS session join procedure with the CN via the RAN to join an MBS session (e.g., events 422, 442). At block 708, the UE determines whether it receives at least one second configuration for the MBS session. When the UE does not receive at least one second configuration for the MBS session, the flow proceeds to block 710. At block 710, the UE receives MBS data of the MBS session in accordance with the at least one first configuration (e.g., events 439, 459). Otherwise, when the UE receives at least one second configuration for the MBS session, the flow proceeds to block 712. At block 712, the UE receives MBS data of the MBS session in accordance with the at least one second configuration (e.g., events 438, 458).

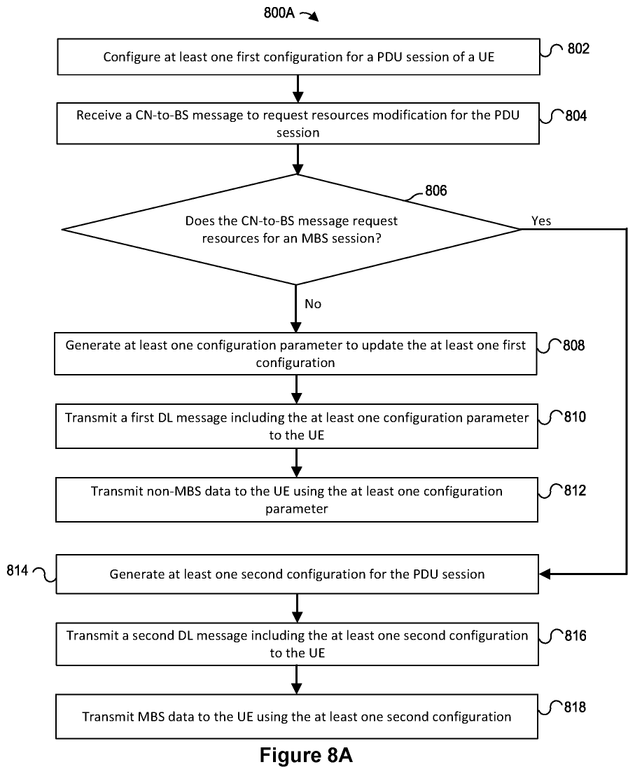

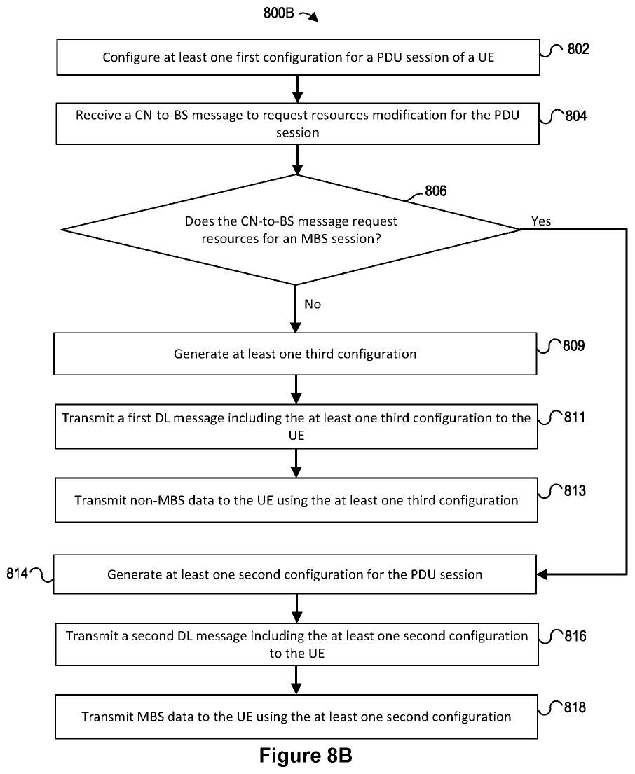

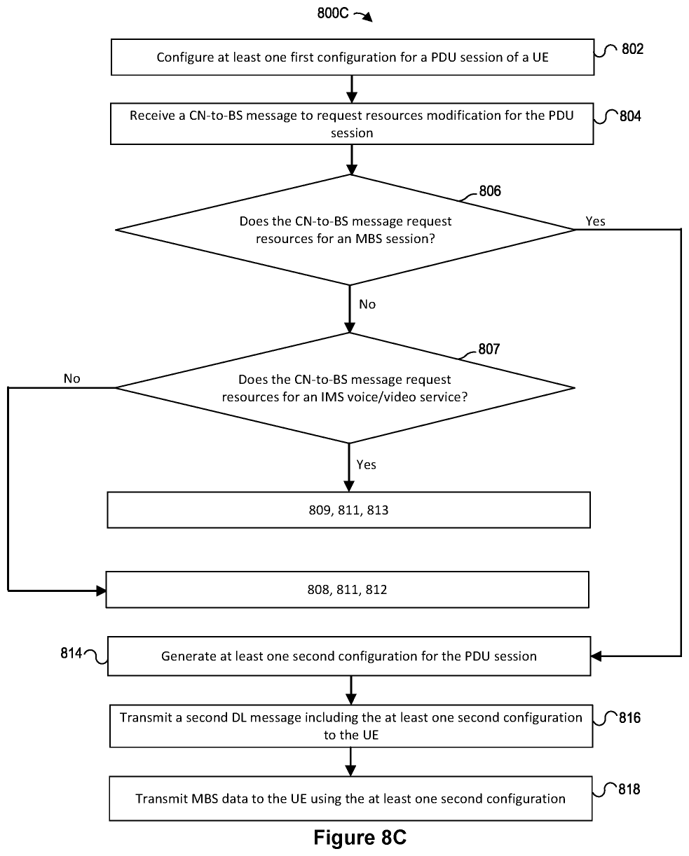

Now referring to FIG. 8A, a base station (BS) such as the base station 104 can implement a method 800 to configure and apply different configuration parameters for transmitting MBS data and non-MBS data respectively.

The method 800A begins at block 802, where the BS configures at least one first configuration for a PDU session of a UE (e.g., event 416). At block 804, the BS receives a CN-to-BS message to request resources modification for the PDU session (e.g., events 424, 444). At block 806, the BS determines whether the CN-to-BS message requests resources for an MBS session. When the BS determines the CN-to-BS message does not request resources for an MBS session, the flow proceeds to block 808. At block 808, the BS generates at least one configuration parameter to update the at least one first configuration. At block 810, the BS transmits a first DL message including the at least one configuration parameter to the UE. At block 812, the BS transmits non-MBS data to the UE using the at least one configuration parameter. Otherwise, at block 806, when the BS determines the CN-to-BS message requests resources for an MBS session, the flow proceeds to block 814. At block 814, the BS generates at least one second configuration for the PDU session (e.g., events 428, 428, 448, 449). At block 816, the BS transmits a second DL message including the at least one second configuration to the UE (e.g., events 428, 428, 448, 449). At block 818, the BS transmits MBS data to the UE using the at least one second configuration (e.g., 438, 439, 458, 459).

In some implementations, the first DL message is a RRC reconfiguration message. In some implementations, the at least one configuration parameter includes some of the unicast configuration parameters of events 416, 429 and/or 449.

In some implementations, if the CN-to-BS message includes a parameter for an MBS session, the base station determines the CN-to-BS message requests resources for an MBS session. Otherwise, the base station determines the CN-to-BS message requests resources for a unicast session (e.g., a PDU session). For example, the parameter can be an MBS session ID of an MBS session. In some implementations, the base station can send a BS-to-CN message to the CN in response to the CN-to-BS message. In some implementations, the CN-to-BS message and the BS-to-CN message can be a PDU Session Resource Modify Request message and a PDU Session Resource Modify Response message, respectively.

In some implementations, the base station can retain the at least one first configuration in cases where the CN-to-BS message includes the MBS session ID. In such cases, the base station indicates the UE to retain the at least one first configuration in the first DL message. In other implementations, the base station can reconfigure one or more configuration parameters in the at least one first configuration in cases where the CN-to-BS message includes the MBS session ID. In such cases, the base station can include reconfigured value(s) of the one or more configuration parameters in the at least one first configuration. In yet other implementations, the base station can release the at least one configuration in cases where the CN-to-BS message includes the MBS session ID. In such cases, the base station indicates the UE to release the at least one first configuration in the first DL message.

FIG. 8B is a flow diagram of an example method 800B, similar to FIG. 8A, except that the method 800B includes blocks 809, 811 and 813 instead of blocks 808, 810 and 812. When the BS determines the CN-to-BS message does not request resources for an MBS session, the flow proceeds to block 809. At block 809, the BS generates at least one third configuration. At block 811, the BS transmits a first DL message including the at least one third configuration to the UE. At block 813, the BS transmits non-MBS data to the UE using the at least one third configuration. In some implementations, the at least one third configuration includes some of the unicast configuration parameters of events 416, 429 and/or 449.

FIG. 8C is a flow diagram of an example method 800C, similar to FIGS. 8A and 8B, except that the method 800B includes blocks 807. When the BS determines the CN-to-BS message does not request resources for an MBS session, the flow proceeds to block 807. At block 807, the BS determines whether the CN-to-BS message requests resources for an IMS voice or video service. When the BS determines the CN-to-BS message requests resources for an IMS voice or video service, the flow proceeds to blocks 809, 811 and 813. Otherwise, at block 807, when the BS determines the CN-to-BS message does not request resources for an IMS voice or video service, the flow proceeds to blocks 808, 811 and 812.

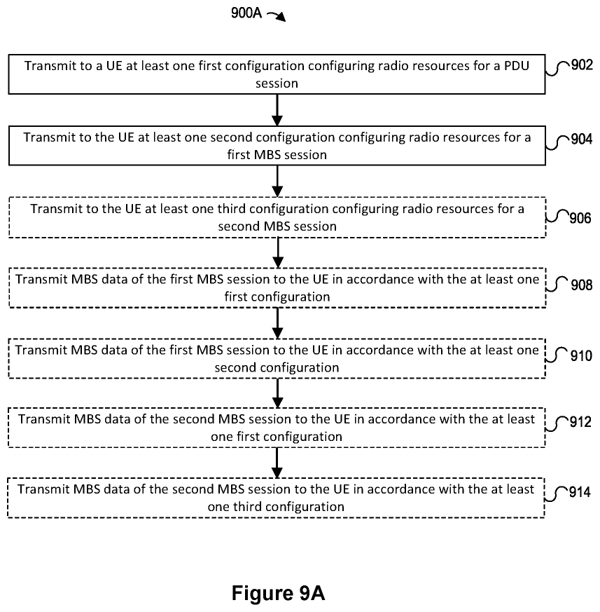

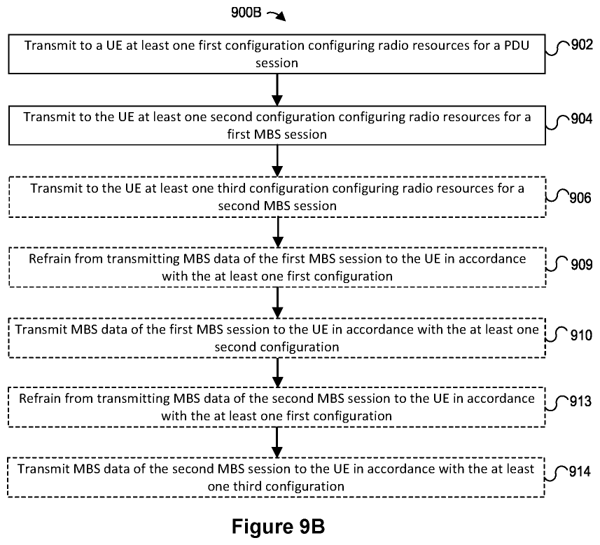

Referring next to FIG. 9A, a base station (BS) such as the base station 104 can implement a method 900A to configure and apply different configuration parameters for transmitting MBS data.

The method 900A begins at block 902, where the BS transmits to a UE at least one first configuration configuring radio resources for a PDU session (e.g., event 416). At block 904, the BS transmits to the UE at least one second configuration configuring radio resources for a first MBS session (e.g., events 428, 429). At block 906, the BS transmits to the UE at least one third configuration configuring radio resources for a second MBS session (e.g., events 448, 449). At block 908, the BS transmits MBS data of the first MBS session to the UE in accordance with the at least one first configuration (e.g., events 438, 439). At block 910, the BS transmits MBS data of the first MBS session to the UE in accordance with the at least one second configuration (e.g., events 438, 439). At block 912, the BS transmits MBS data of the second MBS session to the UE in accordance with the at least one first configuration (e.g., events 458, 459). At block 914, the BS transmits MBS data of the second MBS session to the UE in accordance with the at least one third configuration (e.g., events 458, 459).

Example and implementations of the first, second and third configuration(s) are as described for FIG. 5.

In some implementations, the base station can receive from the UE one or more packets using the at least one first configuration. In some implementations, the UE transmits to the base station the packet(s) (e.g., command(s) or service request(s)) for the MBS session. In other implementations, the UE transmit the packet(s) (e.g., PDCP Control PDU(s)) for operation of a header compression protocol (e.g., interspersed ROHC feedback) to the base station.

FIG. 9B is a flow diagram of an example method 900B, similar to FIG. 9A, except that the method 900B includes blocks 909 and 914 instead of blocks 908 and 912. At block 909, the BS refrains from transmitting MBS data of the first MBS session to the UE in accordance with the at least one first configuration. At block 913, the BS refrains from transmitting MBS data of the second MBS session to the UE in accordance with the at least one first configuration.

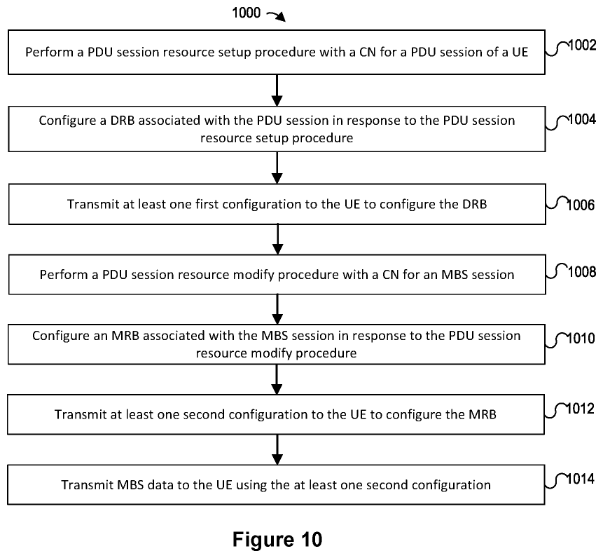

Now referring next to FIG. 10, a base station (BS) such as the base station 104 can implement a method 1000 to configure and apply different configuration parameters for transmitting MBS data.

The method 1000 begins at block 1002, where the BS performs a PDU session resource setup procedure with a CN for a PDU session of a UE (e.g., events 414, 420). At block 1004, the BS configures a DRB associated with the PDU session in response to the PDU session resource setup procedure (e.g., event 416). At block 1006, the BS transmits at least one first configuration to the UE to configure the DRB (e.g., event 416). At block 1008, the BS performs a PDU session resource modify procedure with a CN for an MBS session (e.g., events 424, 434, 444, 454). At block 1010, the BS configures a MRB associated with the MBS session in response to the PDU session resource modify procedure (e.g., events 428, 448). At block 1012, the BS transmits at least one second configuration to the UE to configure the MRB (e.g., events 428, 448). At block 1014, the BS transmits MBS data to the UE using the at least one second configuration (e.g., events 438, 458).

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method in a base station for providing Multicast and/or Broadcast services (MBS) data to a user equipment (UE), the method comprising:
performing, by the base station and with a Core Network (CN), a Protocol Data Unit (PDU) session resource modify procedure for a first MBS session;
responsive to the performing of the PDU session resource modify procedure, configuring, by the base station, an MBS radio bearer (MRB) associated with the first MBS session;
transmitting, by the base station and to the UE, a first at least one configuration for the UE to configure the MRB;
receiving, by the base station and from the CN, first MBS data of the first MBS session;
transmitting, by the base station and to the UE, the first MBS data of the first MBS session in accordance with the first at least one configuration corresponding to the MRB;
transmitting, by the base station and to the UE, a second at least one configuration for configuring radio resources for the UE to establish a second MBS session with the CN; and
transmitting, by the base station and to the UE, second MBS data of the second MBS session in accordance with the second at least one configuration corresponding to the second MBS session, the second MBS data received, by the base station, from the CN.

2. The method of claim 1, further comprising performing, by the base station and with the CN, a PDU session resource setup procedure for a PDU session of the UE prior to the performing of the PDU session resource modify procedure.

3. The method of claim 2, further comprising configuring, by the base station, a data radio bearer (DRB) associated with the PDU session responsive to the performing of the PDU session resource setup procedure.

4. The method of claim 3, wherein the at least one configuration for the UE to configure the MRB is a second at least one configuration, and the method further comprises transmitting, by the base station and to the UE, at least a first configuration for the UE to configure the DRB.

5. The method of claim 1, further comprising establishing, by the base station and with the CN, a common downlink tunnel; and
wherein the receiving of the first MBS data of the first MBS session includes receiving at least a first portion of the first MBS data via the common downlink tunnel.

6. The method of claim 5, further comprising establishing, by the base station and with the CN, a downlink tunnel specific to only the UE; and
wherein the receiving of the first MBS data of the first MBS session includes receiving at least a second portion of the first MBS data via the downlink tunnel specific to only the UE.

7. (canceled)

8. The method of claim 1, further comprising:
establishing, by the base station and with the CN, a first common downlink tunnel corresponding to the first MBS session and a second common downlink tunnel corresponding to the second MBS session;
receiving, by the base station and from the CN via the first common downlink tunnel, at least a first portion of the first MBS data; and
receiving, by the base station and from the CN via the second common downlink tunnel, at least a first portion of the second MBS data.

9. The method of claim 1, further comprising:
establishing, by the base station and with the CN, a first downlink tunnel specific to only the UE and a second downlink tunnel specific to only the UE;
receiving, by the base station and from the CN via the first UE-specific downlink tunnel, at least a second portion of the first MBS data; and
receiving, by the base station and from the CN via the second UE-specific downlink tunnel, at least a second portion of the second MBS data.

10. A base station comprising processing hardware including at least one controller configured to support radio resource control (RRC) configurations and/or RRC procedures, the base station configured to:
perform, with a Core Network (CN), a Protocol Data Unit (PDU) session resource modify procedure for a first Multicast and/or Broadcast services (MBS) session:
responsive to the performance of the PDU session resource modify procedure, configure an MBS radio bearer (MRB) associated with the first MBS session;
transmit, to the UE, a first at least one configuration for the UE to configure the MRB;
receive, from the CN, first MBS data of the first MBS session;
transmit, to the UE, the first MBS data of the first MBS session in accordance with the first at least one configuration corresponding to the MRB;
transmit, to the UE, a second at least one configuration for configuring radio resources for the UE to establish a second MBS session with the CN; and
transmit, to the UE, second MBS data of the second MBS session in accordance with the second at least one configuration corresponding to the second MBS session, the second MBS data received, by the base station, from the CN.

11. The base station of claim 10, wherein the base station is further configured to perform, with the CN, a PDU session resource setup procedure for a PDU session of the UE prior to the performing of the PDU session resource modify procedure.

12. The base station of claim 11, wherein the base station is further configured to configure a data radio bearer (DRB) associated with the PDU session responsive to the performance of the PDU session resource setup procedure.

13. The base station of claim 12, wherein:
the at least one configuration for the UE to configure the MRB is a second at least one configuration; and
the base station is further configured to transmit, to the UE, at least a first configuration for the UE to configure the DRB.

14. The base station of claim 10, wherein:
the base station is further configured to establish, with the CN, a common downlink tunnel; and
at least a first portion of the first MBS data is received via the common downlink tunnel.

15. The base station of claim 14, wherein:
the base station is further configured to establish, with the CN, a downlink tunnel specific to only the UE; and
at least a second portion of the first MBS data received via the downlink tunnel specific to only the UE.

16. The base station of claim 10, wherein the base station is further configured to:
establish, with the CN, a first common downlink tunnel corresponding to the first MBS session and a second common downlink tunnel corresponding to the second MBS session;
receive, from the CN via the first common downlink tunnel, at least a first portion of the first MBS data; and
receive, from the CN via the second common downlink tunnel, at least a first portion of the second MBS data.

17. The base station of claim 10, wherein the base station is further configured to:
establish, with the CN, a first downlink tunnel specific to only the UE and a second downlink tunnel specific to only the UE;
receive, from the CN via the first UE-specific downlink tunnel, at least a second portion of the first MBS data; and
receive, from the CN via the second UE-specific downlink tunnel, at least a second portion of the second MBS data.

18. The method of claim 1, further comprising establishing, by the base station and with the CN, a downlink tunnel specific to only the UE; and
wherein the receiving of the first MBS data of the first MBS session includes receiving at least a first portion of the first MBS data via the downlink tunnel specific to only the UE.

19. The base station of claim 10, wherein:
the base station is further configured to establish, with the CN, a downlink tunnel specific to only the UE; and
at least a first portion of the first MBS data is received via the downlink tunnel specific to only the UE.
